(19) United States
(12) Patent Application Publication
(10) Pub. No.: US 2016/0332852 A1
(43) Pub. Date: Nov. 17, 2016

(54) ARRANGEMENT AND A METHOD FOR TRANSPORTING MATERIAL IN AN ELEVATOR SHAFT

(71) Applicant: KONE Corporation, Helsinki (FI)

(72) Inventor: Antti Mertala, Hyvinkaa (FI)

(73) Assignee: KONE Corporation, Helsinki (FI)

(21) Appl. No.: 15/152,086

(22) Filed: May 11, 2016

(30) Foreign Application Priority Data
May 12, 2015 (EP) 15167333.2

(51) Int. Cl. B66D 1/60; B66D 1/28

(52) U.S. Cl. CPC B66D 1/60; B66D 1/28

(57) ABSTRACT

A material transport arrangement for transporting transportable material in an elevator shaft and a material transport method are disclosed. The arrangement includes a pair of elevator car guide rails and a hoisting system mounted in the elevator shaft above the height to which transportable material is to be transported, for providing a pulling force to move the transportable material. The arrangement includes a pair of lower auxiliary guide rails for guiding the movement of transportable material between a loading position and the pair of elevator car guide rails, a pair of upper auxiliary guide rails at a height above the pair of lower auxiliary guide rails for guiding the movement of transportable material between the pair of elevator car guide rails and an unloading position, and a guide configured to be moveable along the pair of lower auxiliary guide rails, the pair of elevator car guide rails and the pair of upper auxiliary guide rails, and being removably attachable to the hoisting system and to the transportable material to move the transportable material.

### TECHNICAL FIELD

The present disclosure relates to an arrangement and a method for transporting material in an elevator shaft.

### BACKGROUND ART

During the construction of a building, elevator shafts are often used for transporting construction material from the bottom floor to higher floors. Material related to the construction of the elevator and items necessary elsewhere in the construction site can be transported in the elevator shaft.

As long as the elevator shaft is relatively empty, i.e. there is no working platform or an elevator car in the shaft, it is possible to hoist material freely. This can be done, for example, with the aid of a hoisting system, comprising for example a Tirak hoist, mounted at the top part of the elevator shaft. However, when the installation work of the elevator requires a working platform, a scaffold and/or an elevator car to be installed in the elevator shaft, transporting especially bulky material in the elevator shaft becomes more difficult. This typically takes place already at an early stage of the construction, since the progress of the construction project as a whole benefits from the early availability of a functional elevator.

After an working platform and/or an elevator car is installed in the elevator shaft, transportable material can be hoisted by the working platform or the elevator car, but this interferes with the installation work of the elevator, thus slowing it down and incurring additional costs. The problem is especially pronounced for bulky material, which may be too heavy for transport by the working platform or the elevator car.

Especially equipment needed in the finalizing the landing entrance is transported in the elevator shaft. The components, such as doors, door frames and door sills, may be difficult to transport inside the elevator car or the working platform.

Drawbacks of the current solutions are that transporting material in the elevator shaft is dependent on the elevator car or on the working platform. Therefore, while they are used for stationary installation work, material cannot be transported vertically in the elevator shaft. Especially, the drawback of the current methods of elevator installation is that the landing entrance equipment cannot be pre-assembled and transported in the elevator shaft as a pre-assembled landing door arrangement.

The inventors have thus recognized the need for simplifying material transport in the elevator shaft when a working platform or the elevator car is already in place.

### SUMMARY

An object of the present disclosure is to alleviate at least one of the problems related to prior art. Especially, it is the object of the present disclosure to provide a new arrangement and a method for transporting bulky material, such as pre-assembled landing door arrangements, in the elevator shaft.

The material transport arrangement and the method for transporting material according to the present disclosure are in particular, but not only, intended for elevators, especially for passenger or cargo elevators of buildings.

The material transport arrangement according to the present disclosure is characterized by what is presented in claim 1.

The method for transporting material in an elevator shaft according to the present disclosure is characterized by what is presented in claim 15.

The material transport arrangement according to the present disclosure and the method for transporting material in an elevator shaft can offer at least one of the following advantages over prior art:

Transportable material can be transported largely independent of the working platform and/or the elevator car. This improves the efficiency of the installation and saves time and personnel costs.

The material can be loaded on the material transport arrangement according to the present disclosure outside the elevator shaft. Personnel is thus not exposed to falling items in the elevator shaft. The installation work in the elevator shaft above the loading height of the transportable material can therefore continue without interruption while the material is loaded for transport.

Equipment for the landing entrance can be transported directly to the site of installation.

Components of the material transport arrangement according to the present disclosure can be reused at different construction sites.

### BRIEF DESCRIPTION OF DRAWINGS

The accompanying drawings, which are included to provide a further understanding of the disclosure and constitute a part of this specification, illustrate embodiments of the disclosure and together with the description help to explain the principles of the disclosure but the disclosure is not limited to the specific embodiments illustrated in the drawings. In the drawings:

FIG. 1 is a schematic presentation of an embodiment of the material transport arrangement according to the present disclosure as a side view when the transportable material is being loaded.

FIG. 2 is a schematic presentation of an embodiment of the material transport arrangement according to the present disclosure as a side view when the transportable material is being transported.

FIG. 3, panels A to D, presents an embodiment of the material transport arrangement according to the present disclosure as a cross section at different heights.

FIG. 4, panels A to C, presents embodiments of the material transport arrangement according to the present disclosure as a cross section at a height where the guiding means is simultaneously in contact with a pair of auxiliary guide rails and with a pair of elevator car guide rails.

FIG. 5, panels A and B, is a side view of an embodiment of the guiding means according to the present disclosure.

FIG. 6, panels A and B, depicts two exemplary embodiments of the cross section of the lower and upper auxiliary guide rails according to the present disclosure.

FIG. 7 depicts some exemplary embodiments of the auxiliary guide rail profiles according to the present disclosure.

### DETAILED DESCRIPTION

In one aspect, a material transport arrangement for transporting transportable material in an elevator shaft is disclosed. The material transport arrangement comprises
a pair of elevator car guide rails; and
a hoisting system mounted in the elevator shaft above the height to which transportable material is to be transported, for providing pulling force to move the transportable material. The material transport arrangement is characterized in that it further comprises
a pair of lower auxiliary guide rails for guiding the movement of transportable material between a loading position and the pair of elevator car guide rails, each of the lower auxiliary guide rails comprising a first end at the loading position and a second end in the elevator shaft, the second end of the lower auxiliary guide rail being configured to mediate the transfer of transportable material between the pair of lower auxiliary guide rails and the pair of elevator car guide rails;
a pair of upper auxiliary guide rails at a height above the pair of lower auxiliary guide rails for guiding the movement of transportable material between the pair of elevator car guide rails and an unloading position, each of the upper auxiliary guide rails comprising a first end in the elevator shaft and a second end at the unloading position, the first end of the upper auxiliary guide rail being configured to mediate the transfer of transportable material between the pair of elevator car guide rails and the pair of upper auxiliary guide rails; and
guiding means configured to be moveable along the pair of lower auxiliary guide rails, the pair of elevator car guide rails and the pair of upper auxiliary guide rails, and being removably attachable to the hoisting system and to the transportable material to move the transportable material.

The material transport arrangement according to the present disclosure is a temporary assembly which is meant to speed up elevator construction and to reduce idle time during the process. Any elevator construction site can benefit from the material transport arrangement according to the present disclosure. The material transport arrangement according to the present disclosure can be used in elevator shafts comprising more than one independent elevator in parallel. On such sites, the arrangement can be used independently for each elevator.

In the material transport arrangement according to the present disclosure, elevator car guide rails and a hoisting system mounted in the elevator shaft above the height to which transportable material is to be transported, are used for vertically transporting material in the elevator shaft. In elevators, elevator car guide rails are used to guide the vertical movement of an elevator car in an elevator shaft. Elevator car guide rails are usually constructed from guide rail sections that are stacked end-to-end on top of each other. There are typically two guide rails for each elevator car, one on its each side. Such guide rails form a pair of elevator car guide rails. The pair of elevator car guide rails used in the current material transport arrangement can be either finished or under construction. The pair of elevator car guide rails can be used as soon as it has a sufficient length for vertical moving of transportable material. The construction work for the pair of elevator car guide rails can continue during the use of the current material transport arrangement.

By a hoisting system is herein meant a system for moving material in a vertical and optionally in a horizontal direction in the elevator shaft. A hoisting system comprises a device powering the movement of the objects to be moved, i.e. a traction hoist. Many such devices, for example wire rope climbers and winches, are known in the art. A commonly used one is a Tirak hoist. The hoisting system further comprises lifting means, such as a wire rope or a chain, and attachment means, such as a hook or a grapple for holding the object to be lifted. The hoisting system can further comprise automation means for facilitating the operation of the hoisting system and safety devices known in the art.

The hoisting system according to the current disclosure is meant to provide pulling force to move the transportable material. In many applications, the hoisting system pulls the transportable material upwards. However, pulling force can be used also to resist gravity in order to achieve controlled downward movement of the transportable material.

The direction of the pulling force relative to the movement direction of the transportable material can vary during the transport. In other words, the pulling force is not always completely in the same direction as the material movement. Typically at least part of the pulling force is upwards in the direction of the elevator shaft. The pulling force may have a horizontal component in cases where the hoisting system is not mounted directly above the position in which the transportable material is at a given moment.

In addition to the hoisting system used for the material transport arrangement according to the present disclosure, there can be additional hoisting systems for, for example, moving the elevator car or working platform in the elevator shaft. The material transport arrangement according to the present disclosure can comprise more than one hoisting system.

The hoisting system is mounted in the elevator shaft above the height to which transportable material is to be transported. This means any position above the height to which the transportable material is lifted. When the current material transport arrangement is used, the construction work in the elevator shaft has not necessarily progressed very far. For example in such situations, temporary installation decks or lifting beams can be installed at variable heights within the elevator shaft. During the progress of the construction work, the mounting height of the hoisting system can be changed. Typically, the height increases as the construction work progresses.

In one embodiment, the hoisting system is suspended from a lifting beam or from a working deck located above the height to which transportable material is to be transported. The hoisting system can be suspended from at least one lifting beam. By a lifting beam is herein meant a beam running substantially across the elevator shaft and to which one or more hoisting systems are secured. The lifting beam can be at any suitable height within the elevator shaft. Typically the lifting beam is affixed to strong structures at the top of the elevator shaft. It is possible to suspend also the working platform and/or elevator car from a lifting beam. The lifting beam for the working platform and/or elevator car can be the same or a different lifting beam that is used for the hoisting system. In some applications, more than one lifting beam can be used for one hoisting system. Many alternative solutions for installing a lifting beam in the elevator shaft are known in the art and any of them can be used for the material transport arrangement according to the present disclosure.

The hoisting system can be suspended from a working deck. By a working deck is herein meant a temporary assembly substantially covering the elevator shaft at a given height. The working deck can be used for different types of installation works. It can be used as a protection deck to prevent items from falling to the bottom of the elevator shaft.

Other structures can be used for mounting the hoisting system. For example, it might be possible to anchor the hoisting system directly at the wall or ceiling of the elevator shaft. It might also be possible to use suspension means located outside the elevator shaft.

The hoisting system can be controlled by any means known in the art. It can be controlled manually. Alternatively, automatic or semi-automatic control of the hoisting system is possible.

By transportable material is herein meant any material that can be transported by the material transport arrangement according to the present disclosure. The material transport arrangement is primarily meant for transporting elevator components, or installation equipment for elevators. Other material can be transported as well. Examples of transportable material include elevator car guide rail sections, counterweight guide rail sections, landing doors, landing door frames and pre-assembled landing door arrangements. By a pre-assembled landing door arrangement is herein meant a unit comprising landing doors and their frames, including sills, left and right uprights and lintels, the top track, including guide rails and door suspension equipment, as well as necessary electrical connections. In other words, a pre-assembled landing door arrangement is mounted on position and connected to the necessary couplings, after which it is essentially ready to use. A pre-assembled landing door arrangement can be installed from the elevator shaft. Alternatively, a pre-assembled landing door arrangement can be installed from the elevator landing.

The transportable material is transported vertically in the elevator shaft by the material transport arrangement according to the present disclosure. Although in many applications, some of the transport might be in a horizontal direction, the primary transport direction is vertical, for example between landings. By a landing is herein meant a location at which the elevator car can load or unload passengers or cargo. There is an opening in the elevator shaft wall, i.e. a landing entrance, at each landing. Typically, material is transported upwards in the elevator shaft by the current material transport arrangement. However, downward transport is possible. This would be the case, for example, if transportable material is damaged, and the damage takes place or is noticed only after the transportable material has been transported.

The material transport arrangement according to the present disclosure comprises a pair of lower auxiliary guide rails and a pair of upper auxiliary guide rails. Their function is to guide the movement of the transportable material when the movement of the transportable material is not guided by the pair of elevator car guide rails and to mediate the transfer of transportable material to and from the pair of elevator car guide rails. By mediating the transfer between pairs of guide rails is herein meant a system that allows the transportable material to move from one pair of guide rails to the next without being released.

By a pair of auxiliary guide rails is herein meant the pair of lower auxiliary guide rails and the pair of upper auxiliary guide rails. By a pair of guide rails is herein meant the pair of lower auxiliary guide rails, the pair of upper auxiliary guide rails and the pair of elevator car guide rails. By a guide rail is herein meant a guide rail belonging to any pair of guide rails.

The pair of lower auxiliary guide rails guides the movement of the transportable material between a loading position and the pair of elevator car guide rails. Each of the guide rails in the pair of lower auxiliary guide rails has a first end at the loading position. By a loading position is herein meant any position in which the transportable material is loaded on the lower auxiliary guide rails for transport. The loading position can also be used for unloading. This is the case, for example, if transportable material is transported downwards by the current material transport arrangement. Typically, the loading position is near the landing entrance outside the elevator shaft.

The transportable material may be loaded on the lower auxiliary guide rail at the first end of the lower auxiliary guide rail, i.e. at the loading position. Alternatively or additionally, it is possible to load the transportable material on the pair of lower auxiliary guide rails at a position along the auxiliary guide rails, i.e. at a distance from the first end of the lower auxiliary guide rail. The available alternatives depend on the configuration, such as the profile, of the lower auxiliary guide rails.

Further, it is possible to store the transportable material near the landing entrance, or to bring it there from a dedicated storage location. Embodiments can be envisaged in which the pair of lower auxiliary guide rails is used to facilitate the transport of the transportable material from a storage location to the landing entrance. In other words, the pair of lower auxiliary guide rails can extend outside the elevator shaft. The length of the pair of lower auxiliary guide rails can vary. It is also possible to combine the pair of lower auxiliary guide rails with further guide rails used for transporting material in a horizontal direction.

The first end of the lower auxiliary guide rails can comprise means for facilitating the loading or unloading of the transportable material. It can also comprise means for preventing the unwanted release of the transportable material from the pair of lower auxiliary guide rails, such as stoppers.

Each lower auxiliary guide rail has a second end. The second end is configured to mediate the transfer of the transportable material between the lower auxiliary guide rail and an elevator car guide rail. Therefore, the second end of one of the lower auxiliary guide rail is typically near one of the elevator car guide rails. Similarly, the second end of the second auxiliary guide rail in the pair of lower auxiliary guide rails is near the other elevator car guide rail of the pair of elevator car guide rails. For example, the second end of a lower auxiliary guide rail is within 30 cm from the elevator car guide rail. If there is a portion of the lower auxiliary guide rail that is parallel to the elevator car guide rail, the parallel portion can be within 30 cm from the elevator car guide rail. By the second end or a parallel portion of the auxiliary guide rail being within a distance from the elevator car guide rail is herein meant the distance in any horizontal direction. The distance referred to here means the shortest distance to the elevator car guide rail. Naturally, most part of the auxiliary guide rail is further away from the elevator car guide rail. In some embodiments, the second end of the lower auxiliary guide rail is in contact with an elevator car guide rail. The contact may be only at the end of the lower auxiliary guide rail or it may extend for a length of the lower auxiliary guide rail.

Often, but not necessarily, the second end of the lower auxiliary guide rails is at a higher position than the first end.

The transport often begins, i.e. the lower auxiliary guide rail is positioned, at the lowest landing served by the elevator. In other words, the transportable material is loaded at the ground floor of the building. However, the level at which the transportable material is loaded can be anywhere along the height of the elevator shaft. For example, the transportable material can be brought to an intermediated floor by a construction crane and transported therefrom by a material transport arrangement according to the present disclosure. The floor at which the lower auxiliary guide rails are positioned may be changed during the construction work of the elevator.

The pair of upper auxiliary guide rails is located a distance above the pair of lower auxiliary guide rails. The distance between said pairs of auxiliary guide rails varies depending on the application. Typically, the distance is at least one floor interval. Often, the distance is at least two floor intervals. There is no specific upper limit for the distance between the pair of lower auxiliary guide rails and the pair of upper auxiliary guide rails. Practical aspects guide the person skilled in the art to select a suitable distance.

The pair of upper auxiliary guide rails guides the movement of transportable material between the pair of elevator car guide rails and an unloading position. Each of the guide rails in the pair of upper auxiliary guide rails has a first end in the elevator shaft. The first end is configured to mediate the transfer of the transportable material between the elevator car guide rail and the upper auxiliary guide rail. Therefore, the first end of one of the upper auxiliary guide rail is typically near one of the elevator car guide rails. Similarly, the first end of the second auxiliary guide rail in the pair of upper auxiliary guide rails is near the other elevator car guide rail of the pair of elevator car guide rails. For example, the first end of an upper auxiliary guide rail is within a distance of 30 cm from the elevator car guide rail. If there is a portion of the upper auxiliary guide rail that is parallel to the elevator car guide rail, the parallel portion can be within 30 cm from the elevator car guide rail. By the first end or a parallel portion of the auxiliary guide rail being within a distance from the elevator car guide rail is herein meant the distance in any horizontal direction. The distance referred to here means the shortest distance to the elevator car guide rail. Naturally, most part of the auxiliary guide rail is further away from the elevator car guide rail. In some embodiments, the first end of the upper auxiliary guide rail is in contact with an elevator car guide rail. The contact may be only at the end of the upper auxiliary guide rail or it may extend for a length of the upper auxiliary guide rail.

The second end of each upper auxiliary guide rail is at an unloading position. By an unloading position is herein meant any position in which the transportable material is unloaded from the pair of upper auxiliary guide rails. This means the end position of transport by the current material transport arrangement. The unloading position can also be used for loading the transportable material for transport. This is the case, for example, if transportable material is transported downwards.

The unloading position may be in the elevator shaft or outside it. Typically, the unloading position is near the landing entrance inside the elevator shaft. For example, the unloading position can be above a landing entrance so, that transportable material may be easily moved through the landing entrance. Especially in cases where pre-assembled landing door arrangements are transported, the unloading position can be located so that the pre-assembled landing door arrangement can be directly installed to its final position. It is possible to locate the unloading position outside the elevator shaft. This might be advantageous in embodiments where transportable material is construction material other than elevator components.

The second end of the upper auxiliary guide rails can comprise means for facilitating the loading or unloading of the transportable material. It can also comprise means for preventing the unwanted release of the transportable material from the pair of upper auxiliary guide rails, such as stoppers. If the second ends of the upper auxiliary guide rails are inside the elevator shaft, it is especially important that the accidental release of the transportable material is prevented and that the transportable material cannot slide downwards uncontrollably after the transport has come to an end. There are numerous alternatives available to the skilled person to construct the second end of the upper auxiliary guide rail to fulfil the above criteria.

Often, but not necessarily, the second end of the upper auxiliary guide rails is at a higher position than the first end.

The height at which the upper auxiliary guide rails are positioned may be changed during the construction work of the elevator. There may be more than one pair of upper auxiliary guide rails installed simultaneously at different heights in an elevator shaft. In one embodiment, the material transport arrangement comprises at least two pairs of upper auxiliary guide rails at different heights above the pair of lower auxiliary guide rails. It is also possible that there are two or more material transport arrangements according to the present disclosure simultaneously installed in the elevator shaft. In such a case, the two material transport arrangements can be used independently.

The lower and upper auxiliary guide rails can have many different forms. Typically, the pairs of lower and upper auxiliary guide rail have somewhat different form due to the their primarily opposing functions in loading and unloading, respectively. In many embodiments both pairs of auxiliary guide rails are at least partially curved. They may comprise one or more curved regions. The auxiliary guide rails can be curved throughout their length. The sharpness of the curvature can vary within a pair of auxiliary guide rails. The auxiliary guide rails can have straight portions. As the auxiliary guide rails function as pairs supporting the movement of the guiding means, the guide rails in a pair of guide rails have a complementary shape allowing the guiding means to make continuous contact with each of the guide rail.

The exact shape of the guide rails can be determined by the skilled person based on the material being transported. Any shape that allows the transport of transportable material between the loading and unloading positions can be used. Further, the shape can be designed to take the ease of loading and/or unloading of the transportable material into account. The shape of the pair of lower auxiliary guide rails and the shape of the pair of upper auxiliary guide rails can be selected independently of each other.

The cross-sectional size, i.e. the thickness, of the individual lower and upper guide rails depends on the weight of the material to be transported by the current material transport arrangement and thus the strength requirements for the material transport arrangement. Also the material of the auxiliary guide rails is selected partly based on the weight of the transportable material. In one embodiment, the pair of lower auxiliary guide rails and/or the pair of upper auxiliary guide rails are made of profiled steel.

Many different cross-sectional profile alternatives are available for the auxiliary guide rails. In many embodiments, there is one or more surfaces in the auxiliary guide rails, along which the guiding means is configured to move. The surface or surfaces along which the guiding means is configured to move are termed guiding surfaces. The guiding surface may have a curved cross-sectional profile. Alternatively, the guiding surface may have a straight cross-sectional profile with one or more bends. The cross section of the guiding surface can thus be, for example, V-shaped, U-shaped or a combination thereof. The guiding surface forms a guide groove, when the guiding surface is bent inwards, i.e. concave. A guide groove can be designed so that a guide roller can make contact with more than one location. Such a configuration offers the advantage that one guide roller can be used for supporting the guiding means from different directions.

In one embodiment, the cross-sectional profile of the lower auxiliary guide rails and/or the upper auxiliary guide rails forms a guide groove.

Each of the auxiliary guide rails can be individually attached to the structures in the elevator shaft and/or outside the elevator shaft. Any structures that are strong enough to support the load intended to be transported by the current material transport arrangement can be used for attaching the auxiliary guide rails. Examples of structures suitable for attachment are the elevator car guide rails, elevator shaft walls and the floors and ceilings of landings. If the lower auxiliary guide rails are mounted low in the elevator shaft, also the bottom of the elevator shaft can be used. Any strong enough attachment, such as a bracket or a bolt can be used for attaching the auxiliary guide rails. The attachment can be mediated by extension parts, such as steel rods, to accommodate variable attachment positions.

The second end of the lower auxiliary guide rails and the first end of the upper auxiliary guide rails can be mounted independently on either the elevator car guide rail or to any other structures of the elevator shaft. The first end of the lower auxiliary guide rails and the second end of the upper auxiliary guide rails can be mounted independently on the floor or wall structures outside the elevator shaft and/or to the elevator shaft wall.

The guide rails in the pairs of lower and upper auxiliary guide rails can be connected to each other by a connector. Using such a connector may allow the construction of a stronger pair of auxiliary guide rails, but it will make the structure heavier. The connector can be a continuous piece between the guide rails. Alternatively, the connector can comprise one or more separate connecting pieces extending between the guide rails in a pair of guide rails. The profile and material of the connector can vary. The connector can comprise the same material as the auxiliary guide rails. The connector can be detachable from the pair of auxiliary guide rails. Alternatively, it can form an integral part of the pair of the auxiliary guide rails. In other words, the pair of auxiliary guide rails and the connector can form one piece.

The mounting of the auxiliary guide rails is temporary so, that after transportable material has been transported, the auxiliary guide rails can be removed and re-used. Often, only the pair of upper auxiliary guide rails is removed and then re-mounted at a higher position. It is possible to remove also the pair of lower auxiliary guide rails if transportable material is next loaded from another floor. The new loading floor can be higher or lower than the original loading floor.

The lower and upper pairs of auxiliary guide rails are used for moving transportable material to and from the elevator car guide rails. The lower pair of auxiliary guide rails and the upper pair of auxiliary guide rails are positioned so that together with the pair of elevator car guide rails, the form route along which the transportable material can be transported between the loading position and the unloading position.

In many embodiments, the transportable material moves the majority of its total transporting distance along the elevator car guide rails. During this distance, the transportable material is supported by the pair of elevator car guide rails so that the lateral movement of the transportable material is limited. In other words, the elevator car guide rails prevent the uncontrolled swaying of the transportable material in the elevator shaft. Often, the cross section of an elevator car guide rail has a T-profile comprising a blade. In the material transport arrangement according to the present disclosure, each of the two sides of the blade may form a guiding surface.

In cases where a working platform or an elevator car is present in the elevator shaft, it is often not possible to position the hoisting system directly above the space between the elevator car guide rails. The hoisting system therefore is laterally located relative to the transportable material when the transportable material moves along the elevator car guide rails. This, in turn, leads to a horizontal component in the pulling force exerted by the hoisting system on the transportable material. The support given by the pair of elevator car guide rails to the transportable material thus prevents the transportable material from moving horizontally to the direction in which the hoisting system is located. In one embodiment, the hoisting system is located above a position in front of the vertical center-line of a landing entrance. In such a case, the pulling direction of transportable material would allow the positioning to the transportable material directly in front of the landing entrance. If the transportable material is a pre-assembled landing door arrangement, this position might be advantageous for its installation.

The material transport arrangement according to the present disclosure further comprises guiding means. The guiding means is removably attachable to the transportable material. When the guide rails of the current disclosure guide the movement and mediate the transfer of transportable material, the guiding and mediating take place through the guiding means. In other words, the transportable material needs not make contact directly with the guide rails. Since the transportable material is attached to the guiding means, the transportable material moves along with the guiding means.

By removable attachment is herein meant the possibility to repeatedly connect and disconnect components to and from each other. For the guiding means and the transportable material this means that the guiding means is equipped with a material holder through which the transportable material can be attacked to the guiding means and later released. The design of the material holder depends on the transportable material and the skilled person has many alternatives for its design. The material holder can form of multiple parts. It is possible that the transportable material is equipped with corresponding structures and/or equipment for optimizing the attachment between the transportable material and the guiding means. The guiding means may also move along the guide rails without transportable material being attached to it. This is the case, for example, when it is being returned to the loading position for retrieving the next set of transportable material. Alternatively, the guiding means can be returned to the loading position without being in contact with the guide rails. This could be done by simply hanging the guiding means from the hoisting system and lowering or lifting it to the desired height.

The guiding means is removably attachable to the hoisting system. The hoisting system comprises attachment means through which the attachment with the guiding means takes place. The guiding means is equipped with as suitable counterpart. Many ways of accomplishing the removable attachment are known in the art. For example, hooks and grapples can be used.

The guiding means is configured to be moveable along all the three pairs of guide rails present in the current material transport arrangement (i.e. lower auxiliary guide rails, elevator car guide rails and upper auxiliary guide rails). The guiding means makes contact with the guide rails in a manner that allows it to move along the guide rails. Further, the guiding means does not accidentally become released from the guide rails.

Typically, the guiding means comprises guide rollers to mediate the contact with the guide rails. By a guide roller is herein meant any device mediating the contact between a guide rail and an object moving along it, such as guide shoe. Usually one guide roller is in contact with at least one guiding surface of at least one guide rail. In other words, each guide roller can make contact with one or more guide rails. Each guide rail can be in contact with one or more guide rollers.

Typically, a given guide roller can make contact with one guide rail of the lower pair of auxiliary guide rails and the corresponding guide rail of the upper pair of auxiliary guide rails. Another guide roller makes contact with the second guide rail in the pairs of lower and upper auxiliary guide rails. A further guide roller is dedicated for making contact with one of the elevator car guide rails. Similarly, there is yet another guide roller making contact with the second guide rail of the pair of elevator car guide rails.

The guiding means can be constructed in many different ways, depending, for example, on the material to be transported. The guiding means can be a simple suspension frame, from which transportable material hangs. Alternatively, the guiding means can be a sledge-like construction surrounding a large portion of the transportable material.

The construction of the guiding means reflects its functions, which may be numerous in addition to mediating the contact between the guide rails and the transportable material. First, the guiding means can offer structural support to the transportable material. Second, it can comprise means for orienting the transportable material for installation. Third, it can help balancing the transportable material. Fourth, the guiding means may comprise a safety stopper preventing the unwanted downward movement of the guiding means. The design options of the guiding means depend on the targeted use of the material transport arrangement according to the present disclosure and it is within the knowledge of the skilled person to choose appropriate ones.

The auxiliary guide rails may comprise limit switches connected to the controls of the guiding means. This way, the moving range of the guiding means can be restricted. The position of the limit switches can be adjusted for each construction site and according to the transportable material.

To summarize, moving of the transportable material is accomplished by the pulling force provided by the hoisting system, which is mediated to the guiding means, whose movement is controlled by the three pairs of guide rails. The transportable material is removably attached to the guiding means, thus following it between the loading position and unloading position.

The guiding means moves along pairs of guide rails to ascertain the sufficient support for the guiding means in different directions. In other words, since the moving direction of the transportable material changes during its transport, its detachment from the guide rails needs to be prevented.

When the guiding surface forms a guide groove in the guide rail, the sides and the bottom of the groove may offer support in different directions. The transportable material typically starts to be moved in a relatively horizontal or oblique direction along the pair of lower auxiliary guide rails. The movement direction may be vertical at least a part of the length of the lower auxiliary guide rail. The movement direction is essentially vertical, as the transportable material moves along the pair of elevator car guide rails. When the transportable material is moved along the upper auxiliary guide rail, the moving direction may again be oblique or horizontal. Since the hoisting system exerts its pulling force form a single location, the angle of the pulling force relative to the movement direction of the transportable material changes during the transport. To ascertain the efficient functioning of the material transport arrangement, diverting means, such as diverting pulleys or sheaves, may be used to adjust the direction of pull. In one embodiment, the material transport arrangement further comprises diverting means for adjusting the angle of pulling force directed on the guiding means. The diverting means can be fixed to any suitable structures in the elevator shaft or outside it. The diverting means may be fixed stationarily, i.e. they do not move during their operation. Alternatively, they can move during their operation and be mounted on a rail, for example, which in turn is fixed to a suitable structure. The diverting means are typically fixed in a way that they can be removed and re-used. If at least one of the diverting means is located at an intermediate position along the moving path of the guiding means, the lifting means can be configured to be releasable from the diverting means and the diverting means can move horizontally and/or vertically to allow the free movement of the guiding means. A further alternative is that the diverting means is released from the position to which it has been fixed and carried along with the guiding means for the remaining moving distance of the guiding means. There are many alternatives to accomplish such diverting means. The selection of an appropriate one depends on the structure of the components in the material transport arrangement and is within the knowledge of the skilled person.

In one embodiment, the distance between the two guide rails in the pair of lower auxiliary guide rails and the distance between the two guide rails in the pair of upper auxiliary guide rails is the same, and said distance is smaller than the distance between the two guide rails in the pair of elevator car guide rails. When the distance between the guide rails in both pairs of auxiliary guide rails is the same, the design of the guiding means can be simplified. Same guide rollers can be used for mediating the contact between both pairs of auxiliary guide rails. Therefore, in an embodiment, the distance between the two guide rails in the pair of lower auxiliary guide rails and the distance between the two guide rails in the pair of upper auxiliary guide rails is the same.

If both pairs of auxiliary guide rails have a smaller distance between the guide rails than the pair of elevator car guide rails, the pairs of auxiliary guide rails fit between the elevator car guide rails. This might be advantageous when designing the area in which the transportable material is transferred between elevator car guide rails and auxiliary guide rails. In other words, a structure can be designed in the guiding means that makes contact from one side with the auxiliary guide rail and from another side with the elevator car guide rail. In an embodiment, the distance between the two guide rails in the pairs of auxiliary guide rails is smaller than the distance between the two guide rails in the pair of elevator car guide rails.

In one embodiment, the guiding means comprises at least two first guide rollers, each of them being configured to be in contact with one elevator car guide rail, and at least two second guide rollers, each of them being configured to be in contact with one lower auxiliary guide rail and one upper auxiliary guide rail.

The use of separate guide rollers for the auxiliary guide rails and for the elevator car guide rails allows flexibility in the design of the guide rollers. Their size and rotation angle can be designed to suit especially the auxiliary guide rails. Similarly, those guide rollers making contact with the guide rail can be designed to fit them optimally.

Each of the first guide rollers is configured to be in contact with one elevator car guide rail. Each of the second guide rollers is configured to be in contact with one lower auxiliary guide rail and one upper auxiliary guide rail.

Since the guiding means moves along pairs of guide rails, the guiding means comprises at least one guide roller for contacting each guide rail of a pair of guide rails. In some embodiments, more than one guide roller can be in contact with one guide rail. Such a configuration might increase the stability of the guiding means. In such embodiments, there can be, for example, four first guide rollers and four second guide rollers. In some embodiments, there can be, for example, six first guide rollers and six second guide rollers. The number of first and second guide rollers does not need to be equal. Thus, it is possible for the guiding means to comprise, for example, four first guide rollers and six second guide rollers.

It is also possible for the guiding means to comprise at least two third guide rollers making contact with the elevator car guide rail through a surface that is different from the surface to which the first guide rollers are configured to make contact. In one embodiment, the guiding means further comprises at least two third guide rollers, each of them being configured to be in contact with one elevator car guide rail through a surface that is different than the one to which the at least two first guide rollers are configured to make contact, for further supporting the movement of the guiding means.

The first guide rollers are typically configured to make contact with the blade of a T-profiled elevator car guide rail. In such a case, the third guide rollers also make contact with the blade, but from a different side. This leads to the guiding means being pressed against the guide rail from two different directions and thus being secured against swaying to two different directions. In one embodiment, the elevator car guide rails have a T-profile comprising a blade with a first side and a second side, and wherein the at least one first guide roller is configured to move along the first side of the blade and the third guide roller is configured to along move along the second side of the blade. In some embodiments, the third guide rollers are releasable from the elevator car guide rail by a switch.

In one embodiment, the blade of the elevator car guide rail comprises a top surface and the guiding means further comprises at least two fourth guide rollers, each of the fourth guide rollers being configured to move along the top surface of the blade.

By the top surface of the elevator car guide rail blade is herein mean the surface between the two sides of the blade. The top surface forms the top of the blade cross section. The top surface of the blade is typically substantially perpendicular to the first side and the second side of the blade. When the fourth guide roller is configured to move along the top surface of the blade, a third support direction is provided for the guiding means. In other words, the first and third guide rollers are in contact with the blade of the elevator car guide rail from the two sides and the fourth guide roller from a surface that is between the two sides and substantially perpendicular to them.

The top surface of the blade is in many applications narrower than the first and second sides of the blade. This might be reflected in the design of the fourth guide roller. The fourth guide roller may be narrower than the first and third guide rollers. However, each of the first, second, third and fourth guide roller can be designed independently. All of them can thus have a diameter, thickness and material that is well suited for the particular guide roller. Typically the first and third guide rollers have similar structure, as they contact the elevator car guide rail from opposing sides.

In one embodiment, the at least two first guide rollers are releasable from the elevator car guide rail when the guiding means is in contact with the pair of lower auxiliary guide rails or the pair of upper auxiliary guide rails.

As long as the auxiliary guide rails direct the movement of the guiding means, the first guide rollers are typically not necessary for the appropriate movement of the guiding means. Therefore, the first guide rollers can be releasable when the guiding means is in contact with either of the pairs of auxiliary guide rails. The of the guide rollers can be brought about by changing the position of the first guide rollers so that they do not reach the elevator car guide rails. The first guide rollers can, for example, retract or turn. The guiding means comprises a hinge for allowing the position change. The hinge may comprise a locking means allowing the position change of the first guide roller only in response to a signal from a switch.

In one embodiment, the first guide rollers are releasable from the elevator car guide rail by a switch. The switch can be located in the guiding means or in the guide rails. By a switch is herein meant any mechanical, electrical, pneumatic, hydraulic, magnetic or an electromechanical device controlling the change of the roller position so that the releasability of the guide rollers is made possible. The switch can be an electric switch. The switch can be a mechanical switch. The switch can be a pneumatic switch. The switch can be a hydraulic switch. The switch can be a magnetic switch. The switch can be a electromechanical switch. The guide rails and/or the guiding means may comprise additional devices that function together with the switch to control the position at which the roller position is changed. The change of position can be brought about mechanically by structures in the guide rails and/or in the guiding means. In one embodiment, the switch is a mechanical switch, an electrical switch, a pneumatic switch, a hydraulic switch, a magnetic switch or an electromechanical switch. The switch can be removably attachable to an auxiliary guide rail and/or to an elevator car guide rail to indicate the place at which the first guide rollers change their position. Alternatively, the switches can be incorporated into the guiding means and signaling devices may be used on the guide rails to indicate the place of the first guide roller position change.

In one aspect, a method for transporting transportable material in an elevator shaft is disclosed. The method comprises, simultaneously or in any order, the steps of
a) installing a pair of elevator car guide rails in an elevator shaft; and
b) mounting a hoisting system above the height to which transportable material is to be transported, for providing pulling force to move the transportable material.

The method is characterized in that it further comprises the steps of
c) simultaneously or in any order, removably installing a pair of lower auxiliary guide rails for guiding the movement of transportable material between a loading position and the pair of elevator car guide rails, and removably installing a pair of upper auxiliary guide rails at a height above the pair of lower auxiliary guide rails for guiding the movement of transportable material between the pair of elevator car guide rails and an unloading position;
d) simultaneously or in any order, removably attaching guiding means to the transportable material and to the hoisting system, and fitting the guiding means on the pair of lower auxiliary guide rails or on the pair of upper auxiliary guide rails;
e) transporting the transportable material vertically in the elevator shaft along the pair of lower auxiliary guide rails, the pair of elevator car guide rails and the upper auxiliary guide rails, using the pulling force provided by the hoisting system;
f) unloading the transportable material;
g) optionally repeating steps d) to f).

The method according to the present disclosure comprises utilizing a pair of elevator car guide rails and a hoisting system. The steps a) and b), namely installing a pair of elevator car guide rails in an elevator shaft and mounting a hoisting system above the height to which transportable material is to be transported, for providing pulling force to move the transportable material, respectively, can be performed independently of each other. By installing a pair of elevator car guide rails is herein meant installing any length of a pair of elevator car guide rails.

Once the elevator car guide rails and the hoisting system are installed, step c) of the method can be performed. In this step, a pair of lower auxiliary guide rails and a pair of upper auxiliary guide rails are removably installed. By removably installing is herein meant the possibility to repeatedly install and de-install the auxiliary guide rails. It is therefore possible to change the position of both pairs of auxiliary guide rails within one construction site. It is also possible to use the same auxiliary guide rails in more than one construction site. In step c), at least one pair of each auxiliary guide rails is installed.

When the pairs of auxiliary guide rails are in place, the moving components of the material transport arrangement can be connected to each other. In step d), guiding means is removably attached to the transportable material and to the hoisting system, and the guiding means is fitted on the pair of lower auxiliary guide rails or on the pair of upper auxiliary guide rails. The sequence of these steps may be selected freely based on practical aspects. For example, the guiding means can be first fitted on the pair of auxiliary guide rails, then attached to the hoisting system and the transportable material attached last. Alternatively, the transportable material and the guiding means can be first attached to each other and the guiding means then fitted on the pair of guide rails. A further alternative is to first attach the guiding means and the transportable material, then attach the hoisting system to the guiding means and perform the fitting of the guiding means on the pair of auxiliary guide rails last. The last sequence might allow using the pulling force of the hoisting system to help moving the transportable material to the position at which the transport according to the present disclosure will start. The actions in step d) can be performed simultaneously or in any order. This can also mean that embodiments can be envisaged in which multiple guiding means are attached to multiple units of transportable material. This can be performed in a dedicated storage location or in a workshop, for example. It is thus possible to produce pre-assemble packages which are ready for transport.

In step e) the transportable material is transported vertically in the elevator shaft. The transport takes place along the pairs of guide rails and the guiding means is used for making contact with the guide rails.

More than one guiding means can be used at the same time. For example, it is possible that transportable material is being pulled upwards in the elevator shaft while the lower auxiliary guide rail is loaded with the next guiding means and a transportable item attached to it. When the loading position is located outside the elevator shaft, it is possible to load material on the lower auxiliary guide rail also while work in the elevator shaft is ongoing.

At the end of the transport, in step f), the transportable material is unloaded. Unloading can mean detaching the transportable material from the guiding means and leaving the guiding means fitted on the pair of auxiliary guide rails and attached to the hoisting system. Alternatively, unloading can mean detaching the guiding means, and the transportable material along with it, from the pair of auxiliary guide rails. The hoisting system can remain attached to the guiding means or be removed from it.

In most situations, unloading takes place at the unloading position, at the end of the pair of upper auxiliary guide rails. In one embodiment, at step f), the guiding means is substantially at the second end of the upper auxiliary guide rail. However, if the transport has been downwards, unloading may take place in the loading position at the end of the pair of lower auxiliary guide rails, or at another position along the pair of lower auxiliary guide rails.

Step g) of repeating steps d)-f), is optional. In other words, the material transport arrangement according to the present disclosure can be used once and then disassembled. Alternatively, more than one cycle of material transport can be performed with the material transport arrangement. If step g) is performed, the guiding means can be brought back to the position from which the transport of the transportable material began on the first cycle of the method and new transportable material can be attached to it. The guiding means can be returned by the same route as the material was transported. However, if the guiding means is detached from the guide rails, it can be, for example, lowered or lifted directly downwards. Alternatively, new guiding means can be used on each cycle of material transport.

In one embodiment, diverting means is/are used for adjusting the angle of pulling force directed on the guiding means. The diverting means, such as a diverting pulley or a sheave, can be incorporated into the material transport arrangement at any stage during its construction or use.

In one embodiment, the transportable material is a pre-assembled landing door arrangement or a landing door frame or a guide rail. Heavy and/or bulky material is especially suited for transport by the material transport arrangement according to the present disclosure. Thus, the transportable material can be a pre-assembled landing door arrangement. The transportable material can be a landing door frame. The transportable material can be a guide rail. By a guide rail is herein a piece forming at least a portion of a complete guide rail.

### DESCRIPTION OF DRAWINGS

The following figures are to be understood as exemplary embodiments of the material transport arrangement according to the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described below may also be employed without departing from the scope of the invention, which is defined in the accompanying claims.

There are various controlling and safety devices for the material transport arrangement, but all of them have been omitted from the figures for clarity and any conventional methods can be used for their design. All parts of the material transport arrangement are depicted only schematically and their sizes are not drawn proportionally. Further, all additional elevator components are omitted from the figures, although some of them might be present simultaneously with the current material transport arrangement.

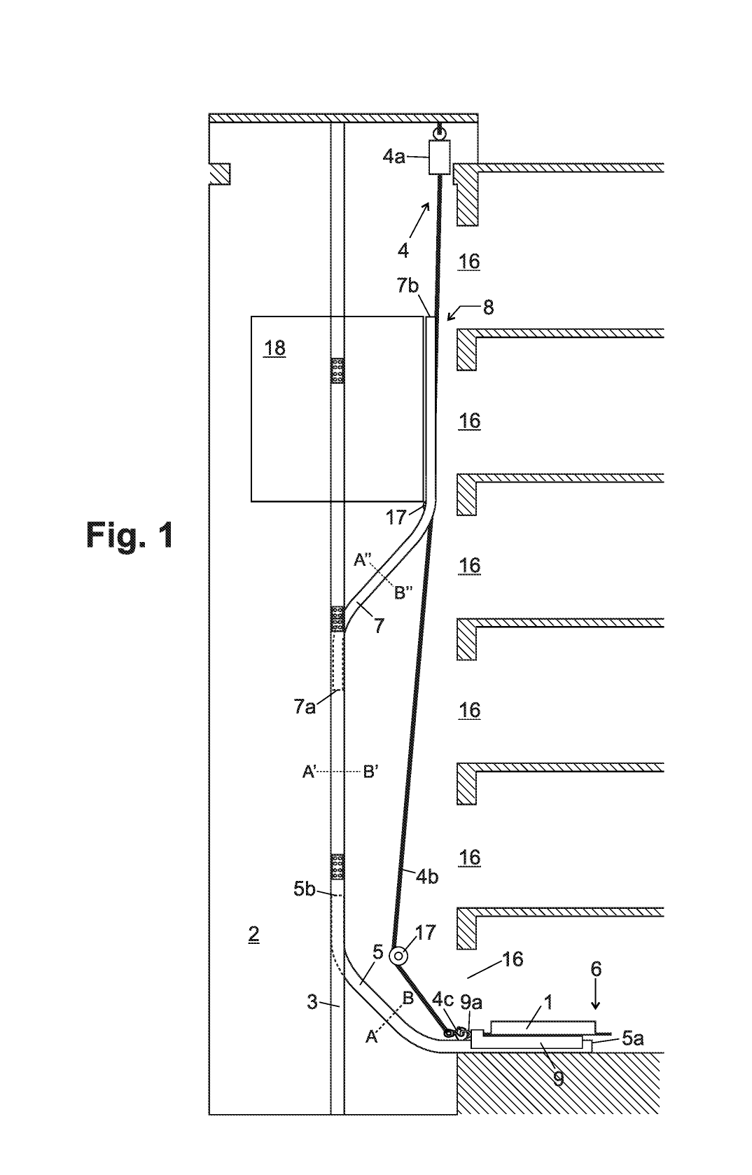

FIG. 1 is a schematic presentation of an embodiment of the material transport arrangement according to the present disclosure as a side view when the transportable material 1 is being loaded. In FIG. 1, an elevator car 18 is depicted in an elevator shaft 2. In the front, an elevator car guide rail 3 is shown. Behind the elevator car guide rail 3 is a second elevator car guide rail 3 of the pair of elevator car guide rails (not shown). Each floor of the building in FIG. 1 comprises an elevator landing entrance 16.

A hoisting system 4 is mounted to the top part of the elevator shaft 2. In this embodiment, the hoisting system 4 is attached to the ceiling of the elevator shaft 2. The hoisting system 4 comprises a traction hoist 4a, lifting means 4b and attachment means 4c. In this embodiment, the traction hoist 4a is a Tirak hoist. The lifting means 4b is a wire rope. The attachment means 4c is a hook. The lifting means 4b is extendable from the traction hoist 4a to the lowest level at which transportable material 1 is kept.

In FIG. 1, a lower auxiliary guide rail 5 and an upper auxiliary guide rail 7 are visible. They are drawn only schematically and structural details are omitted. As the material transport arrangement according to the present disclosure comprises pairs of auxiliary guide rails 5, 7, there is a second guide rail of same shape behind the one depicted in FIG. 1. As both auxiliary guide rails 5, 7 extend parallel to the elevator car guide rails 3, the portion of the auxiliary guide rails 5, 7 that is behind the elevator car guide rail 3 in this viewing direction is depicted with a dashed outline. In the embodiment of FIG. 1, the lower auxiliary guide rail 5 comprises a horizontal portion, the first end 5a of which is in the loading position 6. The loading position 6 is well outside the elevator shaft 2. This allows the loading and/or unloading work at the loading position 6 to continue independently of work in the elevator shaft 2. The horizontal portion of the lower auxiliary guide rail 5 extends into the elevator shaft 2, after which there is an upward bend in the lower auxiliary guide rail 5. After the bend, there is a second straight portion in the lower auxiliary guide rail 5 and a second bend. After the second bend, the lower auxiliary guide rail 5 runs parallel to the elevator car guide rail 3, i.e. substantially vertically. The lower auxiliary guide rail 5 extend a distance parallel to the elevator car guide rail 3 until the second end 5b of the lower auxiliary guide rail 5.

The upper auxiliary guide rail 7 is mounted a distance above the second end 5b of the first auxiliary guide rail 5. The distance is selected so that the transportable material 1 can be transported to the desired height. In most applications, the height to which the transportable material 1 is transported is approximately the height at which the second end 7b of the upper auxiliary guide rail 7 is located.

In FIG. 1, the upper auxiliary guide rail 7 extends parallel to the elevator car guide rail 3 from the first end 7a of the upper auxiliary guide rail 7. There is then a bend towards the side of the elevator shaft 2 and a straight portion extending towards the wall of the elevator shaft 2. A second bend turns the upper auxiliary guide rail 7 vertical. The upper auxiliary guide rail extends in a vertical direction. The upper auxiliary guide rail 7 is at the unloading position 8 close enough to the elevator shaft 2 wall to allow the unloading of the transportable material 1. This is where the second end 7b of the upper auxiliary guide rail 7 is located.

There are many alternatives available to the skilled person to select the shape of the lower and upper auxiliary guide rail 5, 7. For example, the horizontal and vertical portions can be shorter or nonexistent. Instead of two bends, the lower auxiliary guide rail 5 can have one bend.

The embodiment of FIG. 1 comprises two diverting means 17, which in this case are a sheaves. The lower one is fixed to the elevator shaft structures (the attachments are not shown). The lower diverting means 17 is positioned so that the guiding means 9 loaded with transportable material 1 is able to pass the diverting means 17. The diverting means does not need to be aligned with the auxiliary guide rails. The upper diverting means 17 is mounted on the upper auxiliary guide rail 7. The upper diverting means 17 is only partially visible as it is between the pair of upper auxiliary guide rails 7. The sheaves 17 are used to guide the movement of the lifting means 4b. Other positions for the diverting means 17 can be envisaged. Depending on the configuration of the material transport arrangement, there can be, for example one diverting means 17 present in the arrangement. Alternatively, there can be three or more diverting means 17 present in the arrangement. The diverting means 17 can be moveable horizontally and/or vertically.

The auxiliary guide rails 5, 7 can be fixed in place by fixing means (not shown). For example, the lower auxiliary guide rail 5 can be fixed to the floor structures of the height from which the transportable material 1 is transported. The lower auxiliary guide rail 5 may be supported by fixing means attached to the bottom of the elevator shaft 2. The upper auxiliary guide rail 7 may be fixed to the wall of the elevator shaft 2. In this embodiment, the upper auxiliary guide rail 7 is attached to the elevator car 18 (attachment not shown). The first end 7a of the upper auxiliary guide rail 7 is movable in a vertical direction relative to the elevator car guide rail 3. In other words, the upper auxiliary guide rail 7 is not stationarily fixed to the elevator car guide rail 3. Thus, the elevator car can be used to move the upper auxiliary guide rail 7 vertically in the elevator shaft. Alternatively, the upper auxiliary guide rail 7 can be attached to a working platform that is vertically moveable in the elevator shaft 2. The upper auxiliary guide rail 7 may comprise one or more guide rollers or guide shoes for moving along the elevator car guide rail 3. In addition to the fixing means attaching the auxiliary guide rails 5, 7 to the elevator shaft structures, fixing means can be used to attach the auxiliary guide rails 5, 7 to the elevator car guide rails 3.

The material transport arrangement of FIG. 1 further comprises guiding means 9. Its structural details are omitted for clarity. The guiding means 9 is moveable along the pairs of guide rails 3, 5, 7 between the loading position 6 and the unloading position 8. The hook 4c of the hoisting system 4 is attached to the pulling handle 9a of the guiding means 9 for providing pulling force to move the guiding means 9 along the guide rails 3, 5, 7. Transportable material 1 is depicted to be mounted on the guiding means 9.

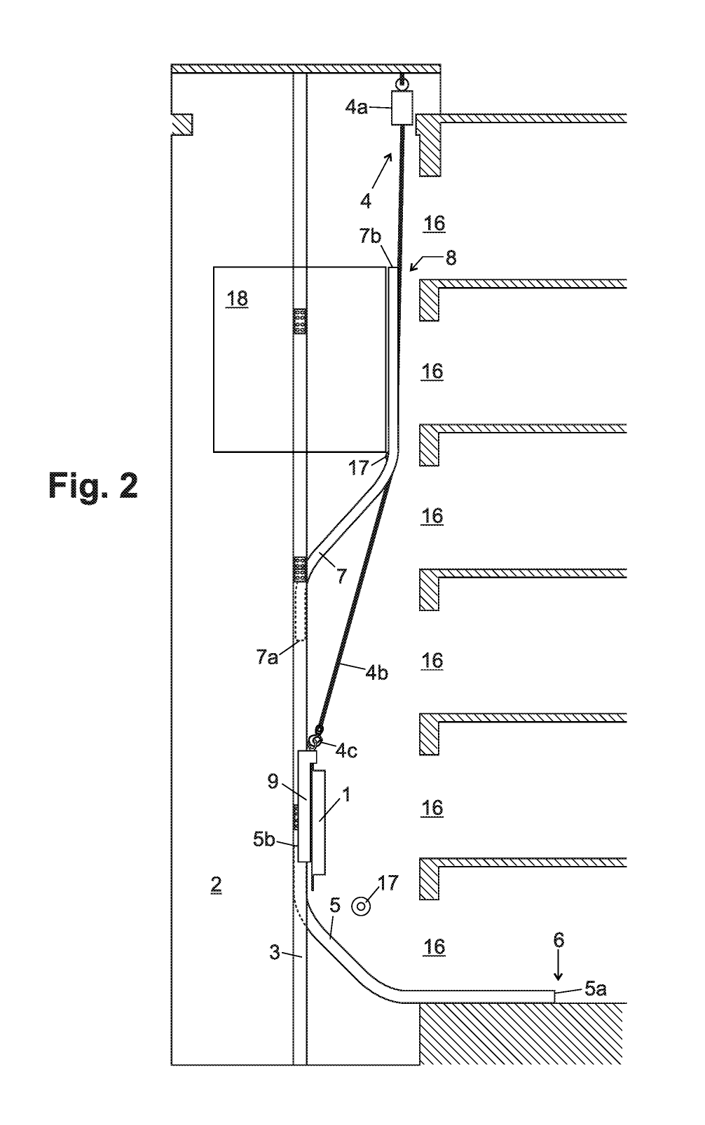

FIG. 2 is a schematic presentation of an embodiment of the material transport arrangement according to the present disclosure as a side view when the transportable material 1 is being transported. The same features as in FIG. 1 are depicted, but the guiding means 9 has been moved along the pair lower auxiliary guide rails 5. In FIG. 2, the guiding means 9 and the transportable material 1 attached to it are in a vertical position, i.e. at a 90 degree angle compared to the position in FIG. 1. Here, it is evident that the transportable material 1 is attached to the guiding means 9 and remains secured to it also when the position of the guiding means 9 changes.

Further, in FIG. 2 is can be seen how the diverting means 17 higher in the elevator shaft 2 functions to divert the lifting means 4b so that it does not touch the elevator car 18. The lifting means 4b has been released from the diverting means 17 lower in the elevator shaft 2, positioned at the lower auxiliary guide rail 5. The lower diverting means 17 has moved horizontally to allow free movement of the guiding means 9.

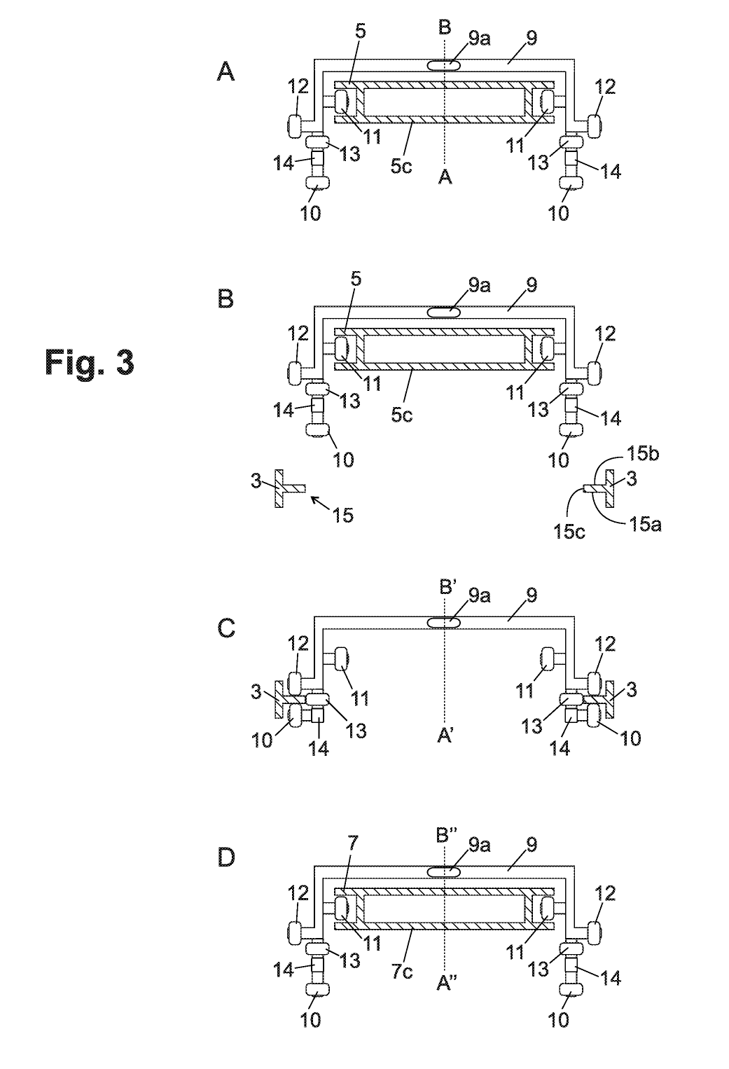

FIG. 3 presents an embodiment of the material transport arrangement according to the present disclosure as a cross section at different heights. Panel A is a cross section at the line A-B in FIG. 1. Panel B is a cross section at a position where the lower auxiliary guide rail 5 is nearing the elevator car guide rails. Panel C is a cross section at the line A′-B′ in FIG. 1. Panel D is a cross section at the line A″-B″ in FIG. 1.

In FIG. 3, guiding means 9 is depicted from the direction of pull, showing also the pulling handle 9a schematically. The guiding means 9 comprises a fist guide roller 10 that is mounted to the side of the guiding means 9. The first guide roller 10 is attached to a switch 14. The switch 14 allows the turning of the axis of the first guide roller 10 by 90 degrees. In the first position, the axis of the first guide roller 10 is aligned with the side of the guiding means 9. Through the functioning of the switch 14, the first guide roller 10 can be turned 90 degrees outwards into a second position. This allows the first guide roller 10 to make contact with an elevator car guide rail 3. There are two first guide rollers 10 visible in FIG. 3, one for each elevator car guide rail 3.

The guiding means 9 further comprises a second guide roller 11, directed towards the auxiliary guide rails 5, 7. In this embodiment, this means towards the interior of the guiding means 9. There are two second guide rollers 11 visible in FIG. 3, one for each auxiliary guide rail 5, 7. The axis of the second guide rollers 11 is attached to the body of the guiding means 9. The attachment can be direct or mediated by an intermediate piece.

The guiding means 9 of FIG. 3 further comprises a third guide roller 12. Its axis has the same direction as the first guide roller 10, when the first guide roller 10 is in the second position (i.e. in the position for making contact with an elevator car guide rail 3). The third guide roller 12 is mounted on the side of the guiding means 9, at a distance from the position at which the first guide roller 10 is mounted. The third guide roller 12 is located at an end of a supporting structure to position the third guide roller 12 appropriately on the elevator car guide rail 3. In this embodiment, the first and third guide rollers 10, 12 move along the two opposing sides 15a, 15b of a guide rail blade 15.

The guiding means of FIG. 3 further comprises a fourth guide roller 13. It is positioned at the side of the guiding means 9. Its axis has the same direction as the first guide roller 10, when the first guide roller 10 is in the first position (i.e in the position for not being in contact with the elevator car guide rail). In this embodiment, the switch 14 and the first guide roller 10 are positioned on a structure that is a continuation of the fourth guide roller 13 axis.

It is possible that there are further guide rollers 10, 11, 12, 13 in the embodiment of FIG. 3, but they are behind the ones depicted in the figure in this viewing direction.

In panel A, the guiding means 9 is drawn above the pair lower auxiliary guide rails 5. In this embodiment, the lower auxiliary guide rails 5 are connected to each other throughout their lengths by a connector 5c. In the position of panel A, the first guide rollers 10, third guide rollers 12 and fourth guide rollers 13 that are configured to make contact with the pair of elevator car guide rails 3 are idle. That is, the first, third and fourth guide rollers 10, 12, 13 do not take part in supporting the guiding means 9. There is a switch 14 in the guiding means 9 of FIG. 3 for each first guide roller 10. Although the switch 14 is drawn visible in FIG. 3, it is possible to construct it so, that is remains within the structure of the guiding means 9 and is thus not visible to the outside. In panel A, the switch 14 holds the axis of each first guide roller 10 aligned with the side of the guiding means 9. The second guide rollers 11 are in contact with the pair lower auxiliary guide rails 5. Each second guide roller 11 is in contact with one guide rail.

Since the angle of the pairs of auxiliary guide rails 5 and 7 varies relative to the hoisting system 4, also the relative direction of pull from the hoisting system 4 changes along the length of the auxiliary guide rails 5, 7. Therefore, the auxiliary guide rails 5, 7 are designed so that the second guide rollers 11 can make contact with more than one surface of the guide rails 5, 7. For example in FIG. 3, the surfaces depicted above and below the second guide roller 11 are designed to make contact with the second guide roller 11. In other words, in the embodiment of FIG. 3, there are two guiding surfaces in each auxiliary guide rail 5, 7.

In panel B, the guiding means 9 is close to the pair of elevator car guide rails 3. In this embodiment, the elevator car guide rails 3 have a T-profile comprising a blade 15. The blade 15 comprises a first side 15a depicted as the lower side of the blade 15 in FIG. 3, and a second side 15b depicted as the upper side. The blade further comprises a top surface 15c.

Since the guiding means 9 has not reached the elevator car guide rails 3 in panel B, the first, third and fourth guide rollers 10, 12, 13 are still idle. The axes of the first guide rollers 10 are aligned with the sides of the guiding means 9.

In panel C, the guiding means 9 runs along the pair of elevator car guide rails 3. The switch 14 has turned the first guide rollers 10 by 90 degrees and each of them runs along the first side 15a of the elevator car guide rail 3 blade 15. The position of the second guide rollers 11 has not changed, but since there is no auxiliary guide rail 5, 7 to make contact with, the second guide rollers 11 are idle. Each third guide roller 12 is in contact with the second side 15b of an elevator car guide rail 3 blade 15. Each fourth guide roller 13 is in contact with the top surface 15c of an elevator car guide rail 3 blade 15.

Each of the first, third and fourth guide rollers 10, 12, 13 supports the guiding means 9 against the blade 15 from one direction. The concerted operation of the first, third and fourth guide rollers 10, 12, 13 thus contributes to the smooth movement of the guiding means 9 along the elevator car guide rails 3.

Each guide roller 10, 11, 12, 13 can have springing or other elastic means. For example, the axis of the guide roller 10, 11, 12, 13 or the guiding means 9 can have one or more helical or leaf springs to dampen uneven movement of the guiding means 9.

In panel D, the guiding means 9 runs along the pair of upper auxiliary guide rails 7. The cross-sectional profile of the pair of upper auxiliary guide rails 7 is identical to that of the pair of lower auxiliary guide rails 5, comprising two connectors 7c. The guiding means 9 is depicted above the pair of upper auxiliary guide rails 7. The first, third and fourth guide rollers 10, 12, 13 are again idle and the first guide rollers 10 turned to have their axes aligned with the side of the guiding means 9.

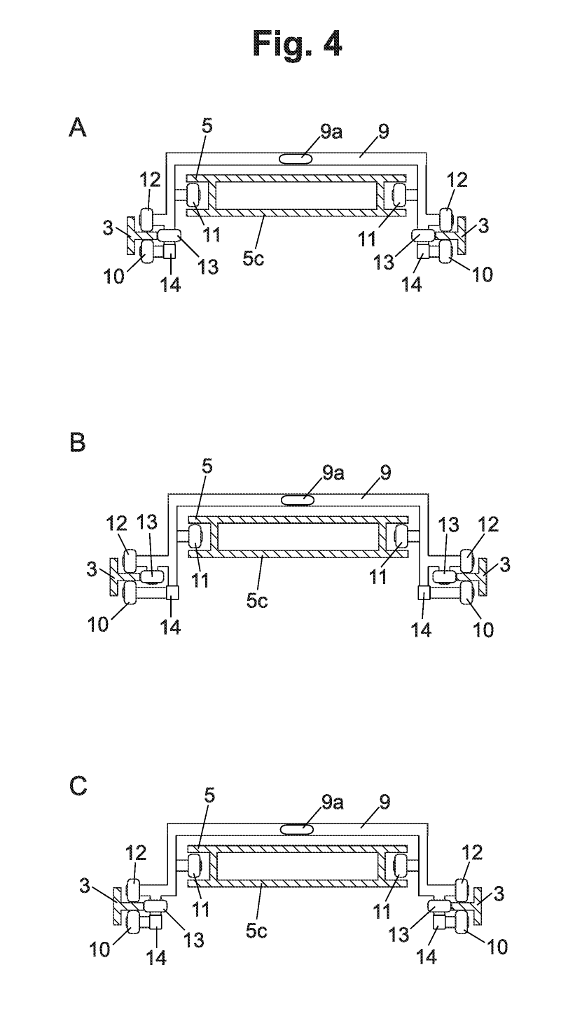

FIG. 4 presents embodiments of the material transport arrangement according to the present disclosure as a cross section at a height where the guiding means 9 is simultaneously in contact with a pair of auxiliary guide rails 5 and with a pair of elevator car guide rails 3.

The embodiment of panel A is the one presented in FIG. 3. In panel A of FIG. 4, all guide rollers 10, 11, 12, 13 are in use supporting the movement of the guiding means 9. The first, third and fourth guide rollers 10, 12, 13 make contact with the elevator car guide rails 3. Both second guide rollers 11 make contact with the lower auxiliary guide rails 5.

Panel B depicts an embodiment of the guiding means 9 in which the first guide roller 10 is mounted on a continuation of the side of the guiding means 9. A switch 14 is used for changing the position of the first guide roller 10. The second guide roller 11 is positioned similarly as in panel A.

In the embodiment of panel B, the third guide roller 12 is mounted on the side of the guiding means 9, at a distance from the position at which the first guide roller 10 is mounted. The third guide roller 12 is positioned so that it can make contact with the elevator car guide rail 3. The third guide roller 12 is located at an end of a supporting structure, as in the previous embodiment. However, in this embodiment, the fourth guide roller 13 is mounted on the structure supporting the third guide roller 12.

In panel C, an embodiment of the guiding means 9 is depicted, in which both the first guide roller 10 and the fourth guide roller 13 are mounted on the supporting structure of the third guide roller 12. There is an additional supporting structure on which the fourth guide roller 13 and the switch 14 controlling the position of the first guide roller 10 are mounted. The supporting structures are designed to position the first, third and fourth guide roller 10, 12, 13 so that each of them can contact the elevator car guide rail 3 from a different direction.

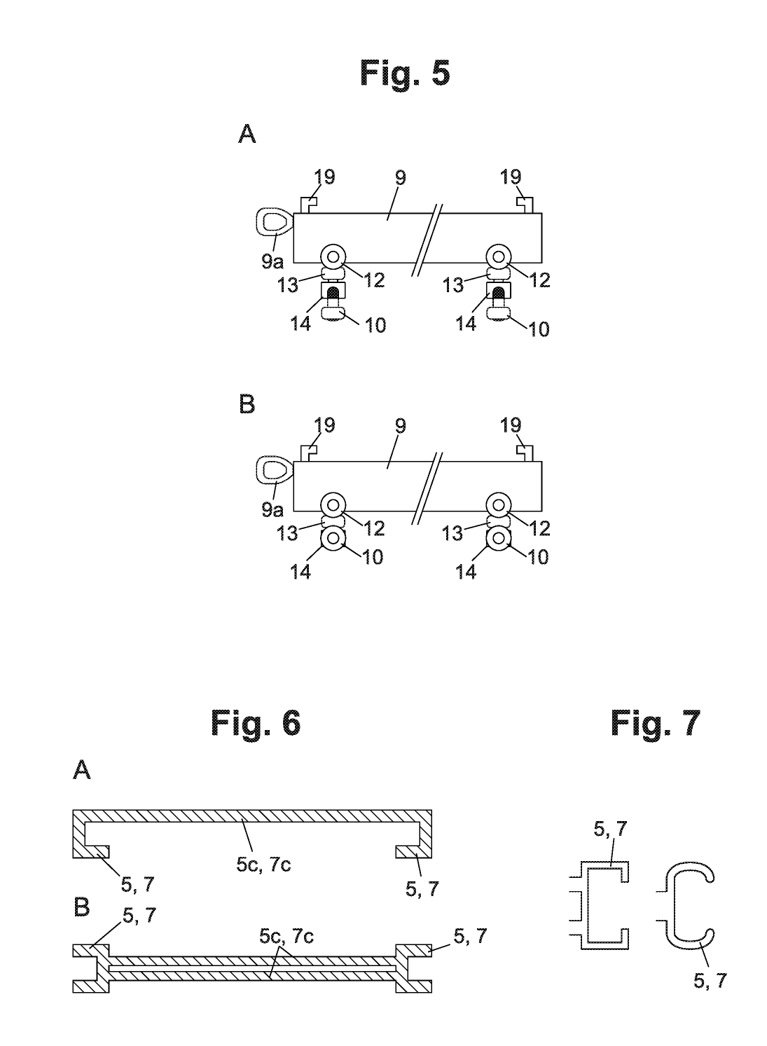

FIG. 5 is a side view, i.e. from the direction of the elevator car guide rail 3, of and embodiment of the guiding means 9 according to the present disclosure. In this embodiment, there are four of each first guide rollers 10, second guide rollers 11, third guide rollers 12 and fourth guide rollers 13. Only the ones closest in the viewing direction are visible. The switch 14 associated with each first guide roller 10 is schematically presented. In panel A, the guiding means 9 is in a configuration in which it does not make contact with the elevator car guide rails 3. The axes of the first guide rollers 10 are parallel to the side of the guiding means 9 (i.e. downwards in the figure). The first guide rollers 10 are thus in the first position. The second guide rollers 11 are not visible as they are behind the third and fourth guide rollers 12, 13 in this viewing direction. However, it would be possible to construct an embodiment, in which the second guide rollers 11 would be staggered relative to the other guide rollers when viewed from the side. In other words, they would not be in the same line with the other guide rollers and could be at least partly visible behind the side of the guiding means 9. In panel B, the guiding means 9 is in a configuration in which it makes contact with the elevator car guide rails 3. The first guide rollers 10 have been turned to the side (i.e. their axes are in the viewing direction of FIG. 4). The first guide rollers 10 are thus in the second position.

In FIG. 4, the material holder 19 of the guiding means 9, which was omitted from the previous figures, is shown. In this embodiment, the material holder 19 comprises hooks that are fittable to the structures of transportable material 1 to secure the transportable material 1 in place for transport.

FIG. 6 depicts some exemplary embodiments of the cross section of the lower and upper auxiliary guide rails 5, 7. In panel A, the guide rails are connected with a single connector 5c, 7c, which is an extension of one side of the guide rail 5, 7. The U-shaped cross-sectional profile of the guide rails 5, 7 is open towards the opposite guide rail 5, 7.

In panel B, the guide rails 5, 7 are connected with two connectors 5c, 7c. The U-shaped cross-sectional profile of the guide rails 5, 7 is open in a direction facing away from the opposite guide rail 5, 7. Embodiments can be envisaged in which the guiding surfaces are in parallel (i.e. ∩ ∩).

FIG. 7 depicts some exemplary embodiments of the auxiliary guide rail profiles according to the present disclosure. The cross-sectional profile of the guide rails 5, 7 can comprise angles and straight portions or it can comprise straight portions and curved portions.

1. A material transport arrangement for transporting transportable material in an elevator shaft, the material transport arrangement comprising:
a pair of elevator car guide rails; and
a hoisting system mounted in the elevator shaft above the height to which transportable material is to be transported, for providing a pulling force to move the transportable material;
a pair of lower auxiliary guide rails for guiding the movement of transportable material between a loading position and the pair of elevator car guide rails, each of the lower auxiliary guide rails comprising a first end at the loading position and a second end in the elevator shaft, the second end of the lower auxiliary guide rail being configured to mediate the transfer of transportable material between the pair of lower auxiliary guide rails and the pair of elevator car guide rails;
a pair of upper auxiliary guide rails at a height above the pair of lower auxiliary guide rails for guiding the movement of transportable material between the pair of elevator car guide rails and an unloading position, each of the upper auxiliary guide rails comprising a first end in the elevator shaft and a second end at the unloading position, the first end of the upper auxiliary guide rail being configured to mediate the transfer of transportable material between the pair of elevator car guide rails and the pair of upper auxiliary guide rails; and
a guide configured to be moveable along the pair of lower auxiliary guide rails, the pair of elevator car guide rails and the pair of upper auxiliary guide rails, and being removably attachable to the hoisting system and to the transportable material to move the transportable material.

2. The material transport arrangement according to claim 1, wherein the distance between the two guide rails in the pair of lower auxiliary guide rails and the distance between the two guide rails in the pair of upper auxiliary guide rails is the same, and said distance is smaller than the distance between the two guide rails in the pair of elevator car guide rails.

3. The material transport arrangement according to claim 1, wherein the material transport arrangement comprises at least two pairs of upper auxiliary guide rails at different heights above the pair of lower auxiliary guide rails.

4. The material transport arrangement according to claim 1, wherein the guide comprises at least two first guide rollers, each of the at least two first guide rollers being configured to be in contact with one elevator car guide rail, and at least two second guide rollers, each of the at least two second guide rollers being configured to be in contact with one lower auxiliary guide rail and one upper auxiliary guide rail.

5. The material transport arrangement according to claim 4, wherein the at least two first guide rollers are releasable from the elevator car guide rail when the guide is in contact with the pair of lower auxiliary guide rails or the pair of upper auxiliary guide rails.

6. The material transport arrangement according to claim 5, wherein the first guide rollers are releasable from the elevator car guide rail by a switch.

7. The material transport arrangement according to claim 6, wherein the switch is a mechanical switch, an electrical switch, pneumatic switch, a hydraulic switch, a magnetic switch or an electromechanical switch.

8. The material transport arrangement according to claim 4, wherein the guide further comprises at least two third guide rollers, each of the at least two third guide rollers being configured to be in contact with one elevator car guide rail through a surface that is different than the one to which the at least two first guide rollers are configured to make contact, for further supporting the movement of guide.

9. The material transport arrangement according to claim 8, wherein the elevator car guide rails have a T-profile comprising a blade with a first side and a second side, and wherein the at least one first guide roller is configured to move along the first side of the blade and the third guide roller is configured to along move along the second side of the blade.

10. The material transport arrangement according to claim 9, wherein the blade of the elevator car guide rail comprises a top surface and the guide further comprises at least two fourth guide rollers, each of the at least two fourth guide rollers being configured to move along the top surface of the blade.

11. The material transport arrangement according to claim 1, wherein the hoisting system is located above a position in front of the vertical center-line of a landing entrance.

12. The material transport arrangement according to claim 1, wherein the hoisting system is suspended from a lifting beam or from a working deck located above the height to which transportable material is to be transported.

13. The material transport arrangement according to claim 1, wherein the cross-sectional profile of the lower auxiliary guide rails and/or the upper auxiliary guide rails forms a guide groove.

14. The material transport arrangement according to claim 1, wherein the material transport arrangement further comprises a diverter for adjusting the angle of a pulling force directed on the guide.

15. A method for transporting transportable material in an elevator shaft, the method comprising, simultaneously or in any order, the steps of:
a) installing a pair of elevator car guide rails in an elevator shaft;
b) mounting a hoisting system above the height to which transportable material is to be transported, for providing a pulling force to move the transportable material;
c) simultaneously or in any order, removably installing a pair of lower auxiliary guide rails for guiding the movement of transportable material between a loading position and the pair of elevator car guide rails, and removably installing a pair of upper auxiliary guide rails at a height above the pair of lower auxiliary guide rails for guiding the movement of transportable material between the pair of elevator car guide rails and an unloading position;
d) simultaneously or in any order, removably attaching a guide to the transportable material and to the hoisting system, and fitting the guide on the pair of lower auxiliary guide rails or on the pair of upper auxiliary guide rails;
e) transporting the transportable material vertically in the elevator shaft along the pair of lower auxiliary guide rails, the pair of elevator car guide rails and the upper auxiliary guide rails, using the pulling force provided by the hoisting system;
f) unloading the transportable material; and
g) optionally repeating steps d) to f).

16. The method according to claim 15, wherein, at step f), the guide is substantially at the second end of the upper auxiliary guide rail.

17. The method according to claim 15, wherein a diverter is used for adjusting the angle of a pulling force directed on the guide.

18. The method according to claim 15, wherein the transportable material is a pre-assembled landing door arrangement or a landing door frame or a guide rail.

19. The material transport arrangement according to claim 2, wherein the material transport arrangement comprises at least two pairs of upper auxiliary guide rails at different heights above the pair of lower auxiliary guide rails.

20. The material transport arrangement according to claim 2, wherein the guide comprises at least two first guide rollers, each of the at least two first guide rollers being configured to be in contact with one elevator car guide rail, and at least two second guide rollers, each of the at least two second guide rollers being configured to be in contact with one lower auxiliary guide rail and one upper auxiliary guide rail.
